(19) United States
(12) Patent Application Publication
(10) Pub. No.: US 2013/0067586 A1
(43) Pub. Date: Mar. 14, 2013

(54) Anti-counterfeit System using product authentication and rewards points

(71) Applicant: Jorge Pagan, San Juan, PR (US)

(72) Inventor: Jorge Pagan, San Juan, PR (US)

(21) Appl. No.: 13/229,457

(22) Filed: Sep. 9, 2011

(51) Int. Cl. G06F 7/04; G06F 15/16; G06Q 99/00; G06F 17/30; G06K 5/00; G06K 19/00

(52) U.S. Cl. 726/26; 235/380; 235/487; 705/317; 705/14.36

(57) ABSTRACT

A authentication system to avoid the consumption of counterfeit products comprising a method using the World Wide Web to verify each individual merchandise using a unique identification number and verifying the unique number against a database online. Further the authentication system comprises a loyalty program in order to encourage customers to use and to denounce counterfeit product sellers.

### STATEMENT REGARDING FEDERALLY SPONSORED RESEARCH AND DEVELOPMENT

N/A

### RELATED APPLICATIONS

N/A

### BACKGROUND OF THE INVENTION

1. Field of the Invention

The present invention is directed to a method and apparatus for retail business inventory and, more particularly, the invention is directed to authentication system for authenticating/validating preventing the sale of counterfeit products.

2. Discussion of the Background

Counterfeit products are often produced with the intent to take advantage of the superior value and quality of the imitated product. These types of products affect manufacturers, more particularly the vision of the public with respect to the manufacturers or brands. The main problem is that the public buy a product expecting the same result and quality of the original product without knowing the product is just an imitation. Counterfeit products cost the government and manufacturers great effort and resources to try to prevent counterfeit products.

Therefore, there is a need to provide a method that assists customer to authenticate/validate a product through an authentication system in order to protect the manufacturers and the customers from buying/selling counterfeit products.

### SUMMARY OF THE INVENTION

The present invention provides an anti-counterfeit system comprising a product package and authentication system. The product package comprises a product with a unique indicia cover with a removable layer, wherein said unique indicia is used to validate said product using said authentication system. The authentication system comprises a programmable machine, a web portal functioning as a point of access to information on the World Wide Web, means to storage data and a service provider having a means for web browsing. Further the authentication system comprises a method to access the storage data through a portal managed by a third party and/or manufacturer and verifying the validity of the products by verifying the unique indicia over the internet at any time and place.

Another object is to provide the customer with a loyalty program as a reward for consuming the product and for providing information in order to eliminate counterfeit products.

Another object is to provide manufacturer with information of places wherein the product is sold or a counterfeit product is sold.

The invention itself, both as to its configuration and its mode of operation will be best understood, and additional objects and advantages thereof will become apparent, by the following detailed description of a preferred embodiment taken in conjunction with the accompanying drawings.

When the word “invention” is used in this specification, the word “invention” includes “inventions”, that is, the plural of “invention”. By stating “invention”, the Applicant does not in any way admit that the present application does not include more the one patentable and non-obviously distinct invention and Applicant maintains that the present application may include more than one patentably and non-obviously distinct invention. The Applicant hereby asserts, that the disclosure of the present application may include more than one invention, and, in the event that there is more than one invention, that these inventions may be patentable and non-obvious one with respect to the other.

Further, the purpose of the accompanying abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

FIGS. 1A through 1B are views of the product package in accordance with the principles of the present invention.

FIG. 2 shows the product revealing the authentication code after the scratch-off layer is removed in accordance with the principles of the present invention.

FIG. 3A shows a general concept of the exchange of information in order to validate a product in accordance with the principles of the present invention.

FIG. 4 shows a general concept of the exchange of information at the manufactures or third party data storage serve in order to validate a product in accordance with the principles of the present invention.

FIGS. 5A through 5B show a flow chart of the manufacturer process for uploading items into the database and an example of a graphical user interface in accordance with the principles of the present invention.

FIG. 6A through 6B show a flow chart of the validation process in accordance and an example of a graphical user interface with the principles of the present invention.

FIG. 7 is a flow chart of the validation process with loyalty program in accordance with the principles of the present invention.

### DESCRIPTION OF THE PREFERRED EMBODIMENT

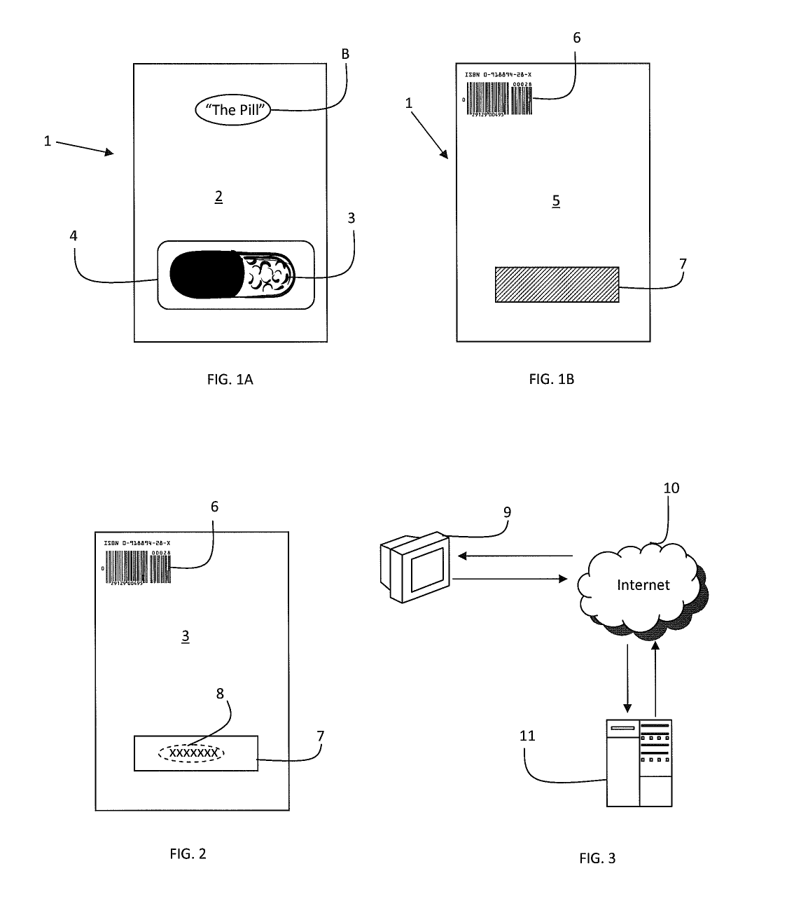

FIGS. 1A through 1B shows an embodiment in accordance with the principles of the present invention. The product package 1 comprises a first side 2 wherein the product 3, such as a pill is encapsulate by mean of a pill package 4 made of translucent material. The product package 1 is labeled in order to provide information regarding manufacturers. For example a brand B is located at the first side 2. The brand serves as trademark which represent, in most cases, for the public an expected quality and value of the product.

FIG. 1B is directed to the second side 5 of the product package 1, wherein the second side 5 comprises a inventory identification indicia 6, and a removable or scratch-off layer 7 which covers the unique indicia 8 for the product.

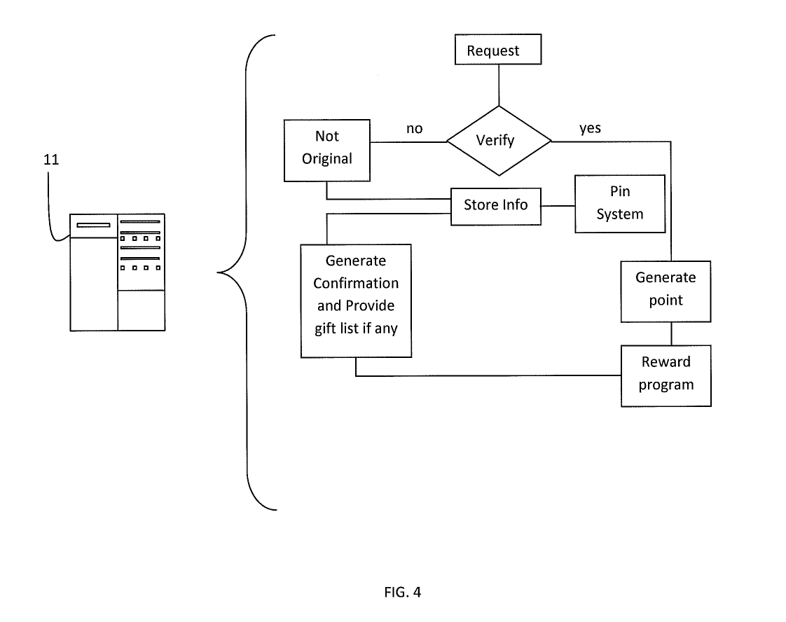

FIG. 2 is directed to the second side 5 revealing the removable layer 7. The unique indicia 8 is used to verify or validate the authenticity of the product 3. The unique indicia 8 is used in combination with the authentication system.

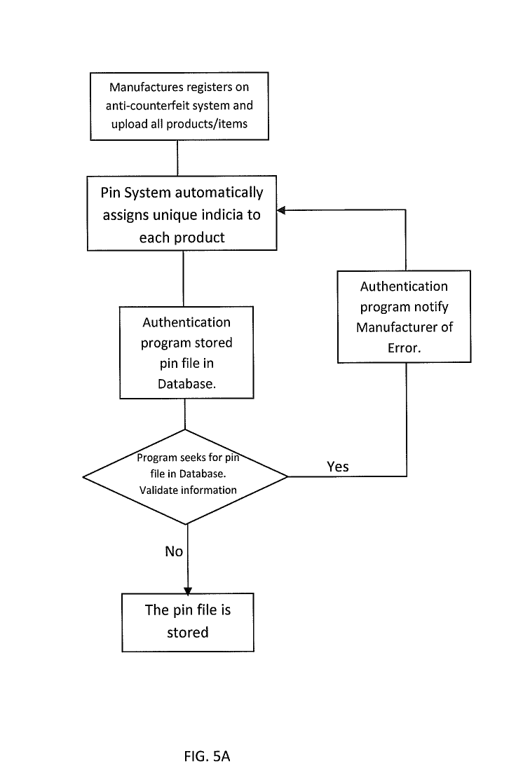

The authentication system, in general and as shown in FIG. 3, comprises a programmable machine 9, such as a computer, mobile phone and any other programmable machine capable of connecting to a global system of interconnected computer networks, such as the internet 10 through a service provider, a database 11 managed by a third and/or manufacturer, an authentication program and a web portal or point of access to the database information.

The database 11 storages information, such as unique indicia of all the distributed products, and operates as a server and is accessed though a web portal. The information at the database 11 is provided by the manufacturers wherein each unique indicia 8 is assigned to a product 3, more particularly to information related to said product 3. For example information assigned to a product 3 comprises store name, inventory identification indicia, expiration date and more information related to the product 3.

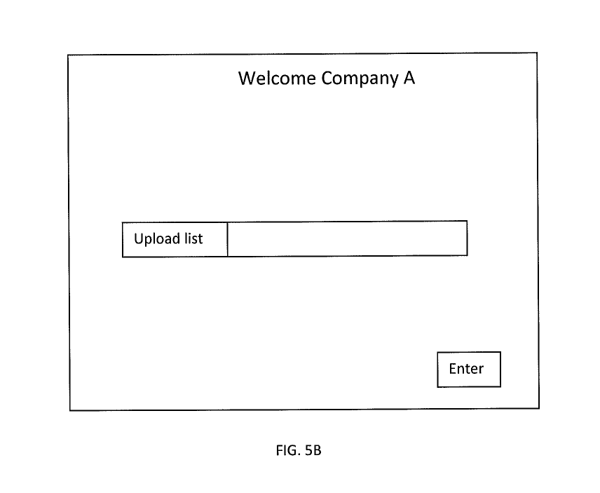

The authentication system further comprises a pin system equipped to generate unique indicia and an authentication program equipped to verifying authentication. The authentication program mainly verifies authenticity of a product 3 after an inquiry is requested through the web portal. FIG. 4 present the general concept of authentication wherein the authentication program accept the request which mainly is an inquiry carrying the unique indicia information, verifies through a matching process the unique indicia information with previously storage information provided by the pin system. In addition confirms authentication of the product or alert the customer of a possible counterfeit product. The system further comprises a loyalty program to encourage user to use original products and to avoid the consumption of counterfeit products. The information is constantly safe at the database 11 in order to keep track and updates of information.

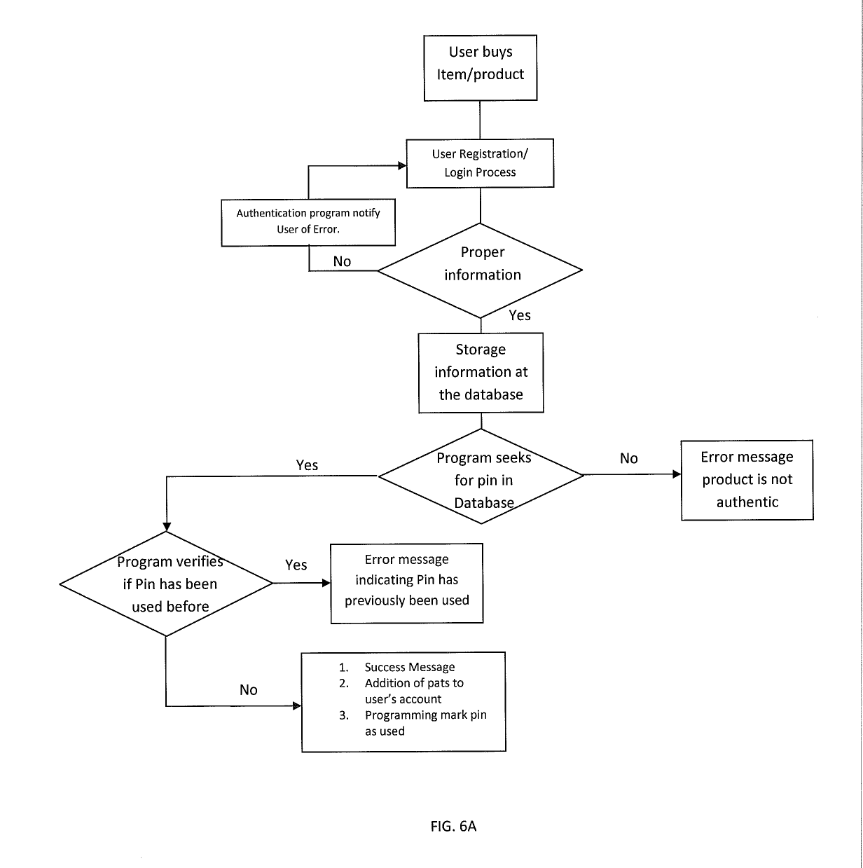

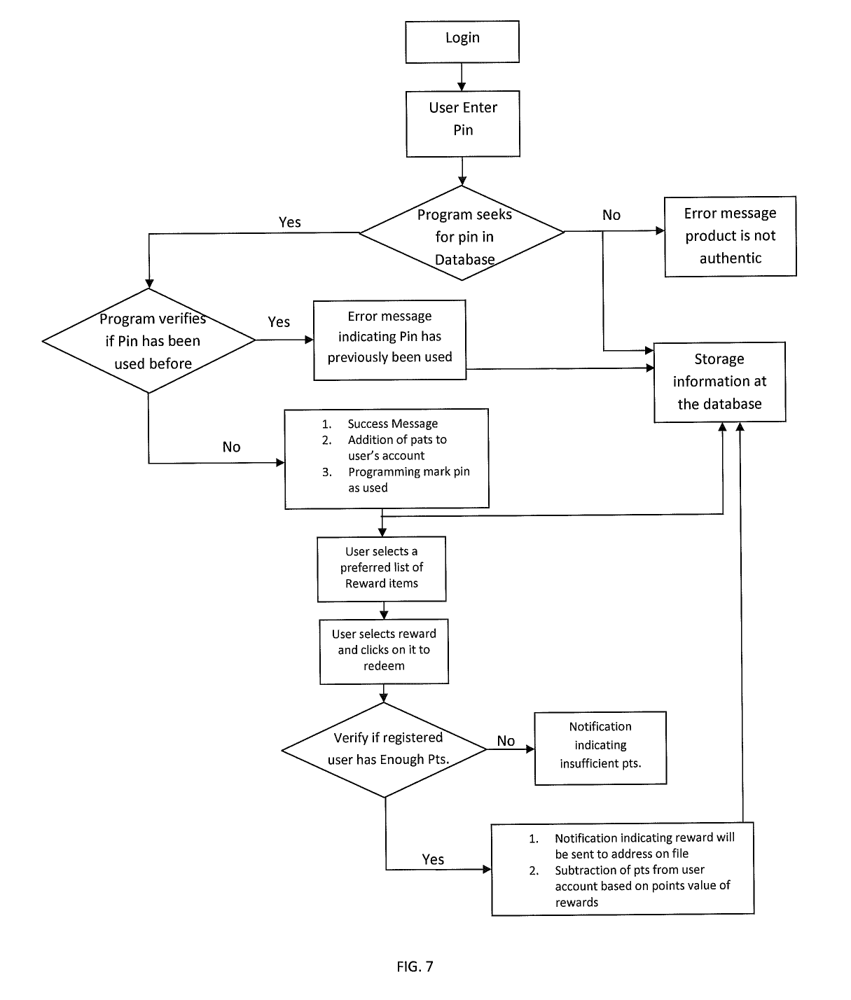

FIG. 5A through FIG. 7 show flow charts for the anti-counterfeit system disclosing the process for assigning unique indicia and verifying authenticity of products in accordance with the principles of the present invention, wherein the product package 1, more particularly the unique indicia 8 is combined with the authentication system to reveal counterfeit products to the user and manufacturers.

As mentioned the authentication system is design to determine if the product is original and further also gain points to trade in for rewards posted on our website.

FIG. 5A is directed to the process to upload information regarding manufacturer items, such as product 3 or product package 1. FIG. 5B is directed to an example of a graphical user interface (GUI) in accordance with the principles of the present invention. The process in accordance with the principles of the present invention comprises the following steps for uploading:
The items list. The item list comprises control number, company name or brand and more.
The pin system generates an unique indicia, wherein said unique indicia is linked to a first product information creating a pin file
Authentication program upload the pin file to the database information storage. The pin files are uploaded in several formats to the database. For example the pin file is uploaded as .csv files to a database.
Authentication program compare previously uploaded information with new information.
If information is the same to previously storage information the Authentication program generates an alert. IF the information is the different to previously storage information the Authentication program storages the information at the database.
The unique indicia is printed on the item and covered with a removable layer or scratchoff.

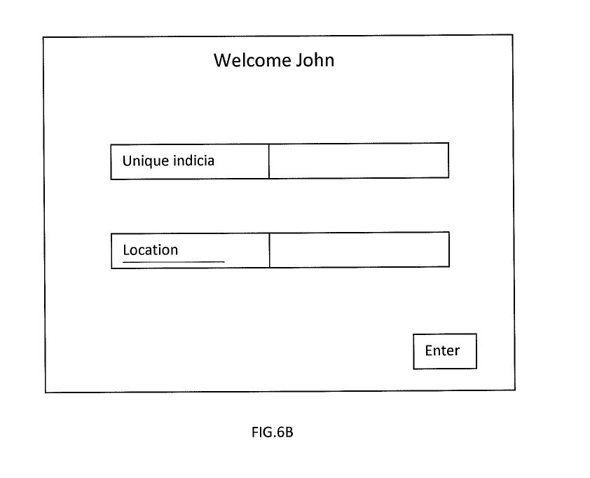

Before the product 1 is distributed to retailers or previously to be consumed by the customer the information is stored. After the product is acquired by the customer the authentication process is performed as shown in FIG. 6A. FIG. 6B is directed to an example of a graphical user interface (GUI) in accordance with the principles of the present invention. The authentication process comprises the following steps:
1. The customer purchases the product and is instructed to go to a website to register and enter the unique indicia.
2. Customer access the authentication system.
3. The authentication system request login password.
4. Customer register in order to create a profile. If the profile was previously created the customer do not have to register. The information supplied by the customer is stored.
5. Customer login to the authentication system. The system request information comprising the unique indicia. Further the requested information may request information, such as the location where the product was bought in order to proceed with the validation process.
6. The requested information, such as unique indicia and location, is stored.
7. The authentication system using a validating software compare the unique indicia entered with the pin file information stored in the database.
8. Several options are provided depending on the evaluation process of comparing the unique indicia entered with the pin file information. The followings are:
If the unique indicia matches an unused pin file in the database, the customer will get a prompt message notifying the customer that the unique indicia is authentic. The process continues.
If the unique indicia entered in the web portal form do not match the database information the programs generate a message to the customer that instructs them to take the product back to the store because it is a copy and not an original product. The process end.
If the unique indicia entered in the website form has already been used, the customer will get a message indicating that the unique indicia has been previously been used. The process end.
9. Further the authentication program recompense the user with rewards points. The points depend on the item. The receive points are added to customer profile.
10. Simultaneously the software updates the database to indicate that the unique indicia has been used, this prevents a user from reentering the same pin more than once.
11. Along with the message that appears when the unique indicia is validated the control number will also be displayed.
12. Further the authentication program provides the option of using the rewards points to redeem several gifts as part of a loyalty program.
13. The loyalty program comprises at least a list of item directed to a particular manufacturer.
14. If the customer selects a gift the system verifies if the customer points are enough to proceed. In case there is no enough point the system will notify the customer. In case there are enough points, the system will ask customer to redeem the point as requested. After approving the redemption of points the system automatically will send the gift to the information obtained during the registration process.
15. The information regarding customer and points is simultaneously updated after approving the redemption of points.

During the registration process the user can create a new profile or just upload a previous profile. Any previous profile can be updated for the client's benefit. During the registration process the user provides information such as, but not limit to, name, address, location, store and preferences. As mentioned before, the authenticity program ask user for the unique indicia in order to verify authenticity. The program verifies the authenticity of the product 3 by means of matching the unique indicia 8 inquiry and the storage data at the database 11.

The results of the evaluation process are saved or stored in the database 11. The data stored from the evaluation process, more particularly the location related to that evaluation process is available for manufacturers in order to avoid the selling of counterfeit product and/or increase advertising efforts on a particular location.

The loyalty program at least comprises a list of items directed to a particular manufacturer, as mentioned. However, the loyalty program can further comprise a combination of item not necessarily from a particular manufacturer. The points to redeem a product vary depending on the anti-counterfeit system administrator preferences.

An example in accordance with the principles of the present invention was disclosed. The general steps for the combination of product and authentication system generally result with the following steps:
1. The manufacture or third party designed an anti-counterfeit system.
2. The anti-counterfeit system generates unique indicia and uploading the pin files to a database which feeds the website.
3. The unique indicia is printed on the products package and covered with a removable layer or scratchoff.
4. The product is distributed. In some cases the retailer information is also added to the pin file.
5. The customer purchases the product and is instructed to go to a website to register and enter the unique indicia.
6. Customer enters the unique indicia in a form on the manufacturer or third party web portal.
7. The authentication system using a validating software checks for the unique indicia by searching for the indicia entered in the website form in our database. A notification depending on the results is provided to the customer. The exchange of data is stored in the data base.
8. Further the program provides the option of using the rewards points to redeem several gifts as part of the loyalty program depending on validation results.
9. If the customer selects a gift the system verifies if the customer points are enough to proceed. In case there is no enough point the system will notify the customer. In case there are enough points, the system will ask customer to redeem the point as requested. After approving the redemption of points the system automatically will send the gift to the information obtained during the registration process.
10. The information regarding customer and points is simultaneously updated after approving the redemption of points.

However, the invention is not limited to the precise configuration described above. While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

1. A counterfeit product comprising:
a first product,
a pin system, wherein said pin system generates pin files and an unique indicia, wherein said pin files linked the unique indicia to a first product information,
a database, wherein the database storages the pin files generated by the pin system; and
wherein said first product is imprinted with the unique indicia and covered with a removable layer.

2. A counterfeit product as in claim 1, wherein the first product is selected from a group of consumable product, dressing products, health products, household products, farm products and entertainment products.

3. A counterfeit product as in claim 1, wherein the first product information is selected from a group of brand, control number, product ingredients and expiration date.

4. A method of recognizing a counterfeit product comprising the steps of:
a first product,
generating a unique indicia,
generating at least one pin file, wherein said pin file comprises a first pin file information, wherein said first pin file information comprises said unique indicia associated to a product information,
generating at least one pin file list at a database,
storing the pin file in the at least one pin file list at the database,
a imprinted unique indicia process comprising imprinting said unique indicia to said first product, and
covering the imprinted unique indicia with a removable layer.

5. The method as claimed in claim 4, further comprising the steps of:
removing the removable layer,
accessing a web portal through a programmable device,
said programmable device comprising a input data member, creating an user profile,
accessing an authentication program at the web portal, wherein said authentication program manages the access to said database,
said authentication program requesting an authentication information, wherein the authentication information comprises the imprinted unique indicia,
entering said authentication information using the input data member,
said authentication program uploading the pin file list,
said authentication program selecting a selected pin file, wherein said selected pin file comprises at least one pin file from the pin file list,
said authentication program matching said imprinted unique indicia with said unique indicia of said selected pin file,
said authentication program uploading the pin file information of said selected pin file,
said authentication program overwriting the pin file information associated with the selected pin file, and storing said selected pin file at the database,
said authentication program generating a verification massage to the user; and
said authentication program editing the user's profile.

6. The method as claimed in claim 5, wherein the input data member is selected from barcode reader, keyboard and an image processing unit.

7. The method as claimed in claim 5, wherein the unique indicia is selected from numbers, barcode, colors, textures and letters.

8. The method as claimed in claim 5, wherein accessing the authentication program comprises
a password; and
a product associated information, wherein the product associated information is selected from time of sale, location of sale and product sale.

9. The method as claimed in claim 5, wherein the verification message is selected from original, already used, counterfeit product.

10. The method as claimed in claim 5, wherein the authentication program edits the selected pin file with information regarding the occasions the selected pin file has been uploaded.

11. The method as claimed in claim 5, wherein the selected pin file is the pin file information that matches with the imprinted unique indicia.

12. The method as claimed in claim 11, wherein the user's profile comprises reward points, wherein the authentication program comprises a reward program, wherein said reward program comprises a reward program process and wherein the step of the authentication program editing the user's profile comprises the overwrite of reward point by means of the reward program.

13. The method as claimed in claim 12, wherein the reward program process further comprising the steps of;
generating at least one reward list at the database, wherein the reward list comprises a plurality of reward products linked to a particular value of reward points,
the reward program comprising means to exchange reward products for reward points,
uploading the reward list,
reward program validates a user request for reward point exchange, and
notifies customer of validation result of user request.
